(19) United States
(12) Patent Application Publication
(10) Pub. No.: US 2011/0133996 A1
(43) Pub. Date: Jun. 9, 2011

(54) ANTENNA FEEDING MECHANISM

(75) Inventor: Pertti O. Alapuranen, Deltona, FL (US)

(73) Assignee: Motorola, Inc., Schaumburg, IL (US)

(21) Appl. No.: 12/957,117

(22) Filed: Nov. 30, 2010

Related U.S. Application Data
(60) Provisional application No. 61/267,615, filed on Dec. 8, 2009.

(51) Int. Cl. H01Q 19/00; H01Q 1/24

(52) U.S. Cl. 343/702; 343/756

(57) ABSTRACT

An access point is provided with an electronics enclosure which is surrounded by antenna panels. An antenna feeding mechanism operates using spatial multiplexing multiple input multiple output. Three radio frequency chains are used in a pattern that feeds a total of eight antenna elements. Multiple streams are supported by using two polarizations. Additionally a maximal ratio combiner is used to combine signals from different antennas. The hardware within the access point supports three radio frequency chains which are mapped to four antenna panels, each panel containing two elements; one for vertical and one for horizontal polarization.

### RELATED APPLICATIONS

The present application is related to and claims benefit under 35 U.S.C. §119(e) from U.S. Provisional Patent Application Ser. No. 61/267,615 filed Dec. 8, 2009, titled “Antenna Feeding Mechanism,” the entire contents of which being incorporated herein by reference.

### FIELD OF THE DISCLOSURE

The present disclosure relates generally to network access points and more particularly to providing an antenna system for a network access point.

### BACKGROUND

Deployments of outdoor Wireless Local Area Networks (WLAN) continues to gain popularity and prevalence. For example, municipalities stand to benefit greatly from investing in a city WLAN network, allowing multiple departments such as public safety, public works, department of transportation, and the like to share access and associated costs.

Municipalities are increasingly looking to wireless broadband technologies to help them save money and enhance city services with advanced mobility applications that include electronic citation processing, automated meter reading, intelligent traffic systems or wireless video security for public safety. Such services require increased data rates and network capacity.

Businesses and education institutions are also finding an increasing need for mobile access across campus environments, seeking solutions that can offer superior throughput and stronger backhaul connections while delivering reliable and secure coverage using fewer access points. Such organizations therefore are looking for a cost-effective wireless broadband solution that has enough capacity, power and throughput to support even the most bandwidth-demanding applications like video and voice.

Achieving the full benefit of WLAN networks outdoors requires a number of elements working together to reach the high network capacities promised by WLAN technologies. (e.g. 802.11n technology). As a result, network designers and planners must carefully consider the network as well as the capabilities of the access points that will be deployed.

A wireless local area network (WLAN) generally includes one or more access points (APs) designed to communicate with wireless client devices. Wireless access points (APs) are specially configured nodes on wireless local area networks (WLANs). Access points act as a central transmitter and receiver of WLAN radio signals. Access points support an “infrastructure” mode within networks. This mode bridges WLANs with a wired backhaul and also scales the network to support more clients.

As used herein, the term “Wireless Local Area Network (WLAN)” refers to a network in which a mobile user can connect to a local area network (LAN) through a wireless (radio) connection. The IEEE 802.11 standards specify some features of wireless LANs. As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA, and all IEEE standards published at the time this application was filed are incorporated herein by reference in their entirety.

Outdoor network access points, (e.g. Mesh Access Points) are thus required to be optimized both in radio hardware and software components, meeting the needs of wide area networks, such as supporting high capacity video and highway-speed mobility.

The antenna systems of such access points therefore need to be optimized to achieve maximum data rates by delivering reliable parallel streams in an outdoor environment using spatial multiplexing or other method where multiple data streams are transmitted in a same frequencies.

An important design consideration in today's access point designs is the overall size, and particularly the vertical dimension of the product. Customers want compact access points of the smallest feasible size due to installation difficulties and aesthetics.

Another important consideration is the rules and regulations governing the use of frequency bands and the maximum allowed transmit power in these bands. Typically the radiated power is measured as Effective Isotropic Radiated Power (EIRP) and its maximum value is regulated.

To deliver high data rates a MIMO (Multiple Input Multiple Output) scheme can be used. In MIMO multiple radio frequency (RF) amplifiers feed antenna elements, typically each transmit antenna has a dedicated RF amplifier.

One of the problems with MIMO is that when a same signal has to be transmitted using multiple elements the antenna system may create radiation peaks when radiated signals from multiple antennas combine constructively. The same signal has to be transmitted for legacy purposes and, for example, as a part of an Orthogonal Frequency Division Multiplex (OFDM) synchronization process.

Another problem with MIMO systems is that when a same signal is transmitted the signals may add destructively creating a radiation null at some angle. The null reduces data rate depending on how much the signal is attenuated from the desired value.

Accordingly, there is a need for a method and apparatus for providing reliable antenna performance of a network access point while integrating such antennas into an aesthetic enclosure.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example implementation of an advanced element panel technology within an access point in accordance with some embodiments.

FIG. 2 and FIG. 3 illustrate various implementations where radio frequency signal to antenna mapping avoids beam forming in accordance with some embodiments.

FIG. 4 illustrates the overlap between radiation patterns of adjacent antenna elements in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One of the important factors in designing an outdoor access point is the size and particularly the vertical dimension of the product. Customers want access points with minimum vertical dimensions due to installation difficulties and aesthetics. To accomplish this requirement, an access point is provided herein with an electronics enclosure which is surrounded by antenna panels, making the product height the same as antenna panel height.

In radio communications, multiple-input and multiple-output (MIMO) is the use of multiple antennas at both the transmitter and receiver to improve communication performance. MIMO technology offers significant increases in data throughput and link range without additional bandwidth or transmit power. It achieves this by higher spectral efficiency (more bits per second per hertz of bandwidth) and link reliability or diversity (reduced fading).

In accordance with some embodiments, for spatial multiplexing (MIMO) (e.g. in a 2.4 Gigahertz (GHz) band) three (3) radio frequency (RF) chains are used in a pattern that feeds total of eight (8) antenna elements. A feeding method for adjacent panels that is beneficial to avoid beam forming when adjacent radiated fields do not use cyclic shift diversity processing is provided herein.

In the MIMO system of some embodiments, line of sight multiple streams are supported by using two polarizations. Additionally a maximal ratio combiner is used to combine signals from different antennas. The hardware supports three (3) RF chains which are mapped to four (4) antenna panels, each panel containing two elements; one for vertical and one for horizontal polarization.

In 802.11n, each RF chain uses a different cyclic shift. The cyclic shift adds sub-carrier rotation that is different for each RF signal. This eliminates the beam forming for overlapping beam patterns for different RF chains. However, when a single RF chain is used for multiple elements there is a potential for detrimental beam forming.

For a typical MIMO direct map operation the chain 1 has to be fed to all elements. For the common feed (Chain 1) two adjacent panels are at ninety (90) degrees to each other and beam patterns have some overlap, (e.g. signals are phased). This can lead to some degree of beam forming at the overlap area.

One of the three signals is the same for the two adjacent panels so the idea is that when two different signals are provided to each panel, (e.g. a different data stream for each polarization), polarizations in adjacent panels can be swapped. This will mainly affect line of sight conditions to avoid nulls while in an environment with reflectors, the polarization conversion will happen and due to reflectors the radio channel can support multiple streams.

This antenna feeding method is especially relevant due to the emerging 802.11n MIMO standard. The large number of antennas required and the size and cost requirements will increase the need for solutions as provided herein.

The embodiments provided enhance beam forming and allow for a high performance access point with a small vertical dimension. The use of this method instead of using more RF chains further provides a lower cost advantage. Additionally, the 802.11n standard only provides up to four (4) cyclic shift diversity processed RF chains.

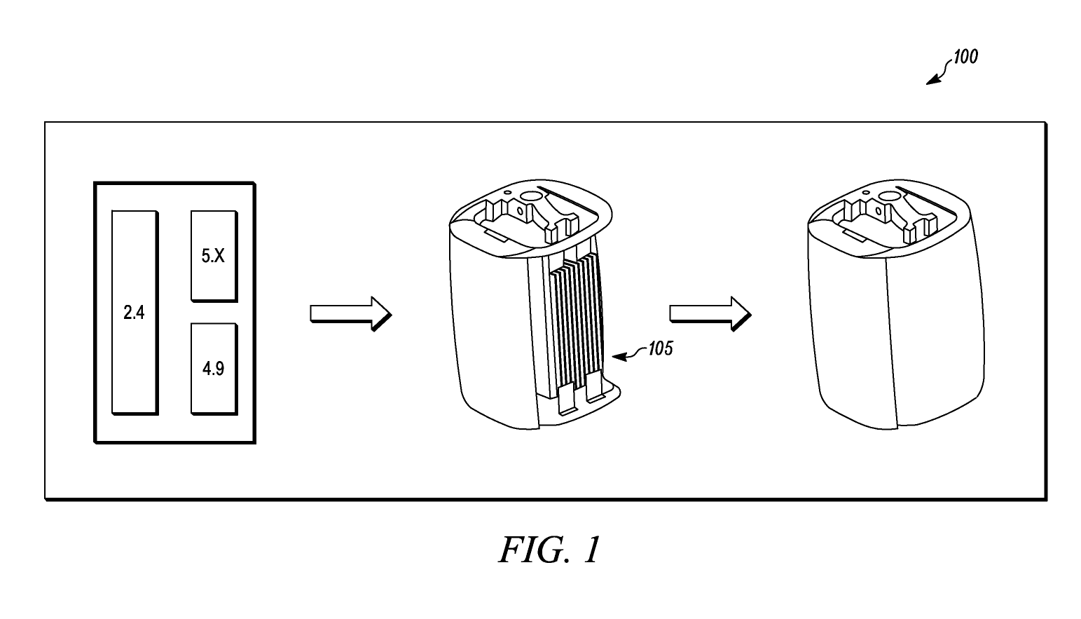

FIG. 1 illustrates an example implementation of an advanced element panel technology within an access point (100). As illustrated, the multi-antenna panels (105) are integrated panels placed at ninety (90) degrees to provide omni-directional coverage. Advanced antenna technology is utilized to combine and separate streams.

The antenna system provides polarization diversity since the panel antennas enable two (2) spatial streams in an outdoor line of sight by creating two dimensions using polarization diversity (horizontal and vertical). A parallel stream is a key element for networks such as 802.11n networks, to offer large increase in range and throughput.

The antenna system further provides self shadowing avoidance since the panel antenna system delivers uniformed gain (+/−1 db at overlapping edge) after all losses due from multiplexing and beam tilting taken into account.

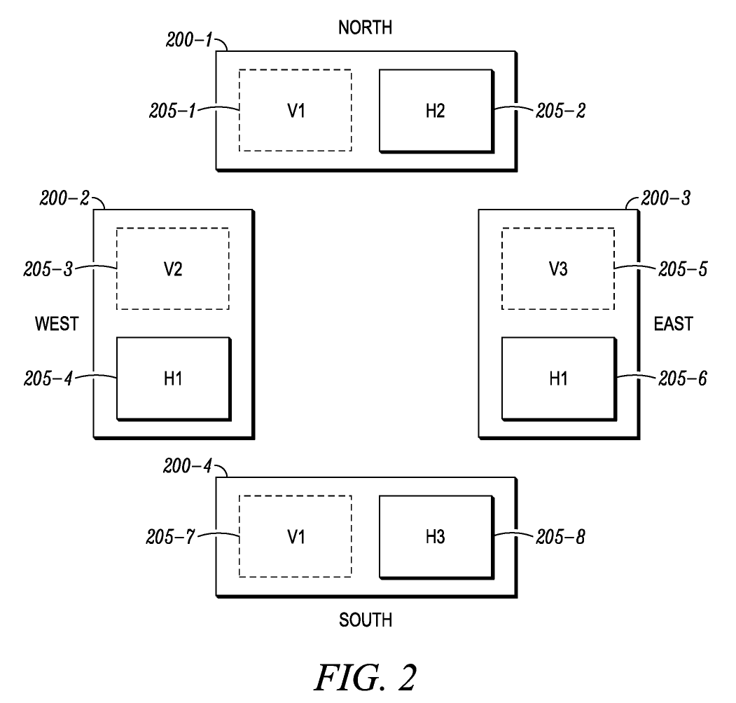

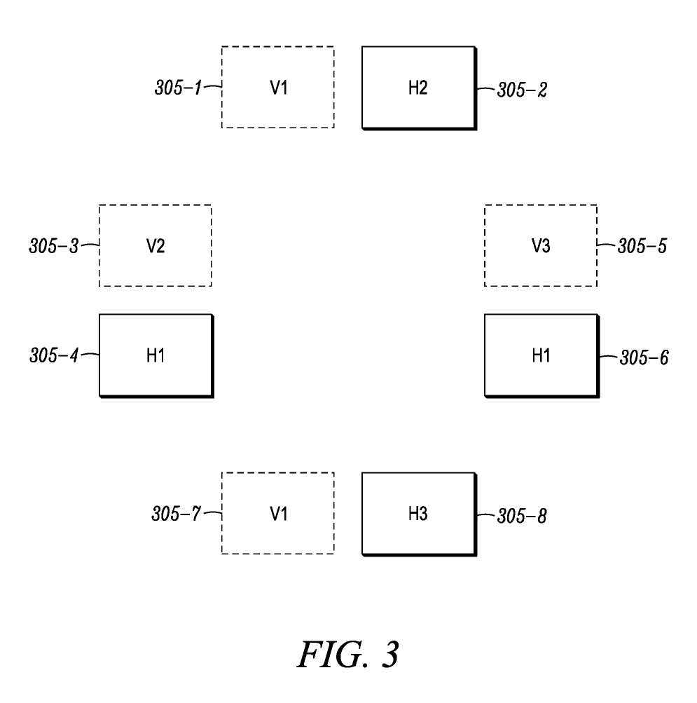

FIG. 2 illustrates an implementation where RF signal to antenna mapping avoids beam forming Another method of achieving the beneficial mapping is illustrated in FIG. 3.

In the provided MIMO system, line of sight multiple streams are supported by using two polarizations. Additionally the product uses a maximal ratio combiner that combines signals from different antennas when in legacy modes. The Baseband and RF hardware supports 3 RF chains per band which are mapped to 4 antenna panels, each panel containing two elements; one for vertical and one for horizontal polarization. Panels are arranged to cover 360 degrees, each panel 90 degrees from the next one, (i.e. panels cover the 4 sides of a cube).

The embodiments described herein provide an antenna panel feeding method where a signal that is fed to all panels is fed to different polarizations in adjacent panels that are 90 degrees (mechanically) from adjacent panels.

As illustrated in FIG. 2, the 4 panels 200-1 through 200-4 at 2.4 GHz are connected to RF chains where 1, 2 and 3 are signals from different RF chains and V and H refers to the polarization (vertical and horizontal) the signal [1,2,3] is connected to. For example, in FIGS. 2, V1 205-1 and 205-7 radiate a first signal and are vertically polarized, V2 205-3 radiates a second signal and is vertically polarized, and V3 205-5 radiates a third signal and is vertically polarized. H1 205-4 and 205-6 radiate the first signal and are horizontally polarized, H2 205-2 radiates the second signal and is horizontally polarized, and H3 205-8 radiates the third signal and is horizontally polarized.

Each panel further radiates to a direction (north, south, east, and west). For example, in FIG. 2, panel 200-1 (V1 205-1, H2 205-2) radiates “north”, panel 200-2 (V2 205-3, H1 205-4) radiates “west”, panel 200-3 (V3 205-5, H1 205-6) radiates “east”, and panel 200-4 (V1 205-7, H3 205-8) radiates “south”.

For MIMO direct map operation the chain 1 has to be fed to all elements. For the common feed (Chain 1) two adjacent panels are at ninety (90) degrees to each other and beam patterns have some overlap, (e.g. signals are phased). This can lead to some degree of beam forming at the overlap area.

One of the three signals is the same for the two adjacent panels so the idea is that when we provide two different signals to each panel, (e.g. a different data stream for each polarization), why not swap polarizations in adjacent panels? This will mainly affect line of sight conditions to avoid nulls while in environment with reflectors the polarization conversion will happen and due to reflectors the spatial diversity exists and we can support multiple streams anyway.

The embodiments illustrated herein use polarization of adjacent panels to reduce beamforming while operating in a system where the number of radiating elements is larger than the number of RF chains. The method operates with system that used cyclic delay diversity (CDD) where intentional phase shifts of OFDM subcarriers are introduced into signal. This means that only same RF chains are causing beamforming if field overlaps. The beamforming is reduced by using different polarization of adjacent panels as described.

FIG. 3 shows three RF chains mapped to 8 antenna elements (305-n). As illustrated, RF chain 1 is fed to vertically polarized antenna elements 305-1 and 305-7 and horizontally polarized antenna elements 305-4 and 305-6. RF chain 2 is fed to horizontally polarized antenna elements 305-2 and 305-8. RF chain 3 is fed to vertically polarized antenna elements 305-3 and 305-5. As illustrated in FIG. 3, no adjacent antenna element has the same polarization when fed with the method herein.

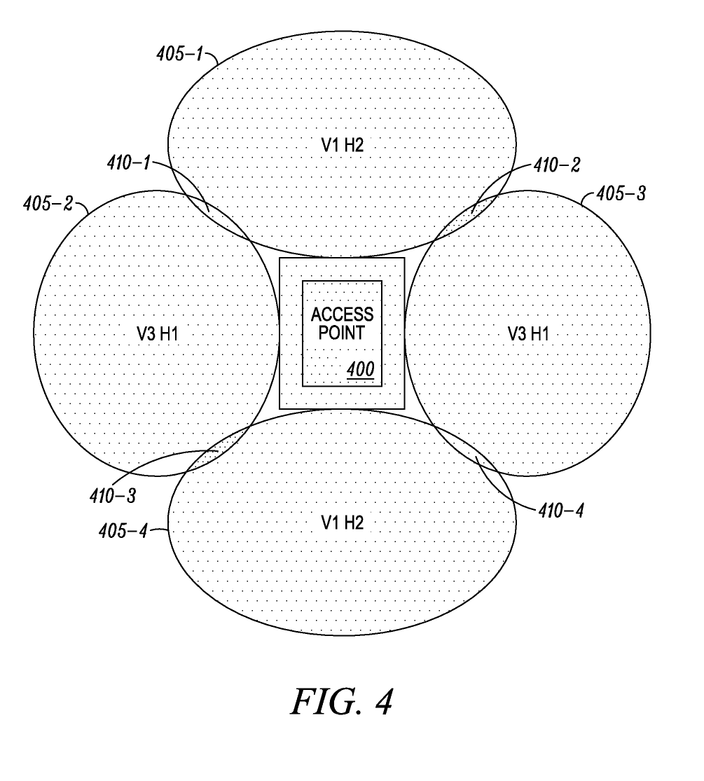

FIG. 4 illustrates the overlap (410-n) between radiation patterns of adjacent antenna elements 405-n of an access point 400. The overlap (410-n) is generally around the forty five (45) degree angle from the normal of each antenna element. Around this horizontal angle the two RF signals from adjacent panels can combine either constructively or destructively when in line of sight.

The fully integrated antenna system provided herein eliminates the self-shadowing interference and coverage challenges inherent to stick antenna designs. Its aesthetically pleasing package brings access point design to an entirely new level.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An access point comprising:
an electronics enclosure; and
a plurality of antenna elements surrounding the electronics enclosure,
wherein the access point operates using a multiple input multiple output antenna feeding mechanism to feed the plurality of antenna elements.

2. The access point of claim 1, wherein the multiple input multiple output antenna feeding mechanism comprises three radio frequency chains used in a pattern to feed the plurality of antenna elements.

3. The access point of claim 2, wherein the plurality of antenna elements comprise four antenna panels each containing two antenna elements, wherein the two antenna elements comprise a vertical polarization antenna element and a horizontal polarization antenna element.

4. The access point of claim 3, further comprising:
a maximal ratio combiner for combining signals from the plurality of antenna elements.

5. The access point of claim 1, wherein the plurality of antenna elements comprise a plurality of integrated antenna panels located at ninety degrees from each other.

6. The access point of claim 1, wherein the plurality of antenna elements comprises four antenna panels arranged such that each antenna panel is ninety degrees from an adjacent antennal panel, each of the antenna panels comprised of a vertical polarization element and a horizontal polarization element.

7. The access point of claim 6, further comprising a hardware system supporting three radio frequency chains per frequency band which are mapped to the four antenna panels.

8. The access point of claim 7, wherein the three radio frequency chains comprise a first radio frequency signal, a second radio frequency signal, and a third radio frequency signal, and wherein the four antenna panels comprise a first antenna panel, a second antenna panel, a third antenna panel, and a fourth antenna panel; and wherein the access point is configured such that:
a vertical polarization element of the first antenna panel and a vertical polarization element of the third antenna panel radiate the first frequency signal, wherein the first antenna panel and third antenna panel are located one hundred and eighty degrees apart;
a vertical polarization element of the fourth antenna panel radiates the second radio frequency signal, wherein the fourth antenna panel is located adjacent to and ninety degrees from the first antenna panel and the third antenna panel;
a vertical polarization element of the second antenna panel radiates the third radio frequency signal, wherein the second antenna panel is located adjacent to and ninety degrees from the first antenna panel and the third antenna panel and one hundred eighty degrees from the fourth antenna panel;
a horizontal polarization element of the fourth antenna panel and a horizontal polarization element of the second antenna panel radiate the first radio frequency signal; and
a horizontal polarization element of the third antenna panel radiates the third radio frequency signal.

9. The access point of claim 8, wherein the first antenna panel radiates in a north direction, the second antenna panel radiates in an east direction, the third antenna panel radiates in south direction, and the fourth antenna panel radiates in a west direction.
